(19) United States
(12) Patent Application Publication
(10) Pub. No.: US 2016/0097787 A1
(43) Pub. Date: Apr. 7, 2016

(54) SMART BAND, MOTION STATE DETERMINING METHOD OF THE SMART BAND AND COMPUTER-READABLE RECORDING MEDIUM COMPRISING PROGRAM FOR PERFORMING THE SAME

(71) Applicant: ZIKTO, Seoul (KR)

(72) Inventors: Kyung Tae KIM, Seoul (KR); Sung Hyun KIM, Seoul (KR); David Hansuk SUH, Seoul (KR)

(21) Appl. No.: 14/519,897

(22) Filed: Oct. 21, 2014

(30) Foreign Application Priority Data
Oct. 2, 2014 (KR) 10-2014-0133167

(51) Int. Cl. G01P 13/00; G01P 15/00; G01P 3/00

(52) U.S. Cl. CPC G01P 13/00; G01P 3/00; G01P 15/00

(57) ABSTRACT

Provided are a smart band, a motion state determining method of the smart band, and a computer-readable recording medium including a program for performing the same. The smart band includes: a motion sensor that detects a user's motion and creates motion data; a memory that stores a normal motion score of a user; and a control unit that determines scores of first to third factors, which are standards for determining a user's motion state, on the basis of the created motion data, calculates a final score on the basis of the determined scores of the first to third factors, and determines the user's motion state by comparing the normal motion score with the final score.

### CROSS-REFERENCE TO RELATED APPLICATION

This application claims priority from Korean Patent Application No. 10-2014-0133167 filed on Oct. 2, 2014 in the Korean Intellectual Property Office, and all the benefits accruing therefrom under 35 U.S.C. 119, the contents of which in its entirety are herein incorporated by reference.

### TECHNICAL FIELD

The present invention relates to a smart band, a motion state determining method of the smart band, and a computer-readable recording medium including a program for performing the same.

### BACKGROUND

A smart band is a wristband capable of searching various services such as diaries, messages, alarms, and stock quotations through wireless communication. Further, users can download data and can set their accounts through a web browser, depending on services.

Recently, there is an increasing need for a healthcare service through smart bands with increasing concern on those smart bands.

### SUMMARY

The present invention has been made in an effort to provide a smart band that provides an alarm in real time when the health degree in walking is out of a predetermined range of standard, by analyzing the health degree.

The present invention has also been made in an effort to provide a method of determining the motion state of the smart band that provides an alarm in real time when the health degree in walking is out of a predetermined range of standard, by analyzing the health degree.

The present invention has also been made in an effort to provide a computer-readable recording medium containing a program for performing the method of determining the motion state of the smart band that provides an alarm in real time when the health degree in walking is out of a predetermined range of standard, by analyzing the health degree.

The objects of the present invention are not limited to those described above and other objects may be made apparent to those skilled in the art from the following description.

An embodiment of the present invention provides a smart band including: a motion sensor that detects a user's motion and creates motion data; a memory that stores a normal motion score of a user; and a control unit that determines scores of each of first to third factors, which are standards for determining a user's motion state, on the basis of the created motion data, calculates a final score on the basis of the determined scores of each of the first to third factors, and determines the user's motion state by comparing the normal motion score with the final score.

The motion data may contain acceleration or rotation angular velocity of the user's motion.

The score of the first factor may be determined on the basis of first movement time when a user's arm reaches a first peak angle in a first direction of arm swing directions by a user walking and second movement time when the user's arm reaches a second peak angle in a second direction opposite to the first direction, from a state when the user's arm is in parallel with the user's body.

The larger the sum of the first and second movement time, the smaller the score of the first factor may be.

The score of the first factor may be determined on the basis of the rotation angular velocity of the user's motion.

The score of the second factor may be determined on the basis of a first peak displacement in a third direction crossing the first direction of arm swing directions by a user walking and a second peak displacement in a fourth direction opposite to the third direction, from a state when the user's arm is in parallel with the user's body.

The larger the sum of the first and second peak displacements, the smaller the score of the second factor may be.

The score of the second factor may be determined on the basis of the acceleration of the user's motion.

The score of the third factor may be determined on the basis of frequency analysis on the integral value of rotation angular velocity of the user's motion.

The frequency analysis is performed by Fourier transform on the integral value of the rotation angular velocity, and the larger the ratio of the sum of the magnitudes of the other peaks to the magnitude of the first peak in a frequency domain of the integral value of the rotation angular velocity, the smaller the score of the third factor may be.

The score of the third factor may be determined on the basis of the rotation angular velocity of the user's motion.

The smart band may further include an alarm unit that alarms a user, when the final score is lower than the normal motion score.

Another embodiment of the present invention provides a method of determining a motion state of a smart band, which includes: detecting a user's motion and creating motion data; determining scores of each of first to third factors, which are standards for determining a user's motion state, on the basis of the created motion data; calculating a final score on the basis of the determined scores of each of the first to third factors; and determining the user's motion state by comparing the normal motion score with the final score.

The determining of the score of the first factor may include: measuring, several times, first movement time when a user's arm reaches a first peak angle in a first direction of the arm swing directions by a user walking and second movement time when the user's arm reaches a second peak angle in a second direction opposite to the first direction, from a state when the user's arm is in parallel with the user's body; and determining the score of the first factor on the basis of the averages of each of the first and second movement time.

The larger the sum of the first and second movement time, the smaller the score of the first factor may be.

The determining of the score of the first factor may include: measuring, several times, a first peak displacement in a third direction crossing a first direction of the arm swing directions by a user walking and a second peak displacement in a fourth direction opposite to the third direction, from a state when the user's arm is in parallel with the user's body; and determining the score of the second factor on the basis of the averages of each of the first and second peak displacements measured several times.

The larger the sum of the first and second peak displacements, the smaller the score of the second factor may be.

The determining of the score of the third factor may include transforming the integral value of the rotation angular velocity of a user's motion into a frequency domain through Fourier transform and determining the score of the third factor on the basis of the ratio of the sum of the magnitudes of the other peaks to the magnitude of the first peak in the frequency domain of the integral value of the rotation angular velocity.

The method may further include registering a normal motion score of a user to be compared with the final score, before the detecting of a user's motion and creating of motion data.

The method may further include alarming a user, when the final score is lower than the normal motion score.

A computer-readable recording medium of the present invention for achieving another embodiment described above includes a program for performing the method of determining a motion state of a smart band.

The details of the present invention are included in the following detailed description and the accompanying drawings.

### BRIEF DESCRIPTION OF THE DRAWINGS

The above and other features and advantages of the present invention will become more apparent by describing in detail embodiments thereof with reference to the attached drawings in which:

FIG. 1 is a diagram illustrating a smart band according to an embodiment of the present invention and a smartphone linked to the smart band;

FIG. 2 is a block diagram illustrating the smart band according to an embodiment of the present invention;

FIGS. 3 to 6 are diagrams illustrating scores of first to third factors determined by a control unit illustrated in FIG. 2;

FIG. 7 is a flowchart illustrating a method of determining a motion through the smart band according to an embodiment of the present invention; and

FIG. 8 is a flowchart illustrating steps for registering a normal motion score of a user of FIG. 7.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, and the like may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

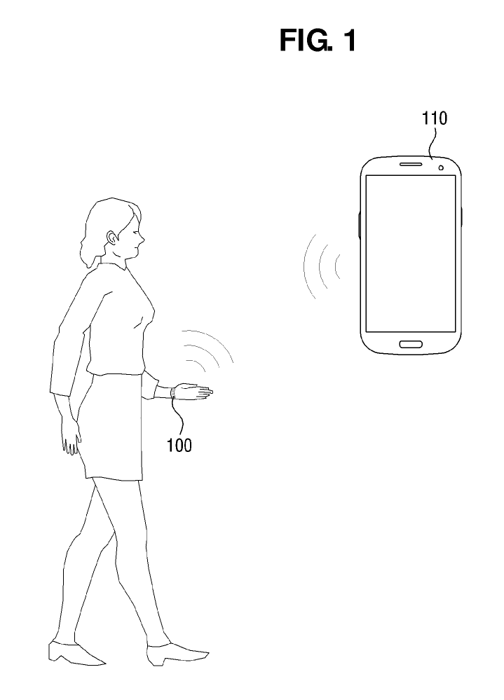

Hereinafter, a smart band according to an embodiment of the present invention and a smartphone linked to the smart band are described with reference to FIG. 1.

FIG. 1 is a diagram illustrating a smart band according to an embodiment of the present invention and a smartphone linked to the smart band.

Referring to FIG. 1, a smart band 100 according to an embodiment of the present invention and a smartphone 110 can communicate with each other, using local communication. The smart band 100, which can be put on a human body (for example, an arm) by a band, has a motion sensor and determines the motion state of a user by detecting a motion of the user with the motion sensor. Accordingly, the user can be provided with his/her motion state (for example, walking) in real time only by walking with the smart band 100 on his/her body without a specific action. The motion state of the user detected through the smart band 100 can be provided to the smartphone 110 too through local communication.

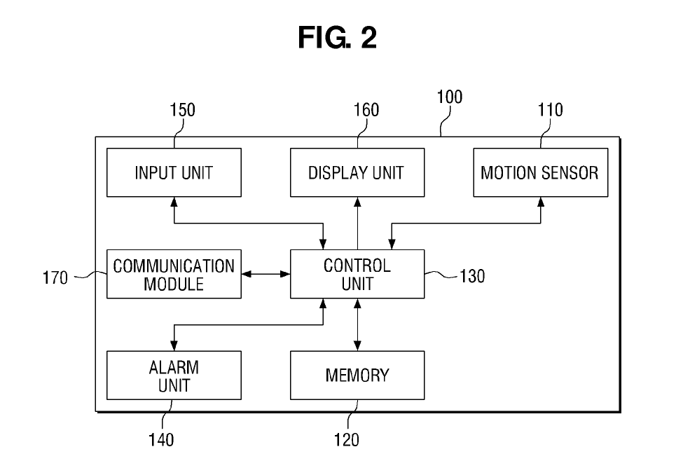

The smart band according to an embodiment of the present invention is described hereafter with reference to FIG. 2.

FIG. 2 is a block diagram illustrating the smart band according to an embodiment of the present invention.

Referring to FIG. 2, the smart band 100 according to an embodiment of the present invention includes a motion sensor 110, a memory 120, a control unit 130, an alarm unit 140, an input unit 150, a display unit 160, and a communication module 170.

The motion sensor 110 can create motion data by detecting a motion of a user.

In detail, the motion sensor 110 may include a sensor such as an acceleration sensor or a gyroscope and is activated periodically or by the control unit 130, so it detects a motion of a user and creates and sends motion data including the detection result to the control unit 130.

The motion data may include acceleration or a rotation angular velocity of a motion of a user, but is not limited thereto.

The memory 120 stores a normal motion score of a user.

In detail, the memory 120 stores microcodes and reference data of a program for processing and controlling of the control unit 130, temporary data created during execution of various programs, and updatable various data needed to be stored. In particular, the memory 120 can store a registered normal motion score of a user.

The control unit 130 can detect a motion of a user through the motion sensor 110, create motion data, and determine the motion state of the user on the basis of the motion data.

In detail, the control unit 130 can determine the motion state of a user by determining the scores of first to third factors, which are standards for determining the motion state of the user, on the basis of motion data created by the motion sensor 110, calculating the final score from the scores of the first to third factors, and then comparing the final score with the normal motion score.

The first to third factors will be described in detail below.

The alarm unit 140 can inform a user of his/her motion state (for example, the health degree in walking) on the basis of the calculation result of the control unit 130.

In detail, the alarm unit 140 can alarm a user, when the final score calculated by the control unit 130 is lower than the normal motion score stored in the memory 120. Further, the alarm unit 140 can alarm a user to recognize his/her motion state (for example, when walking of the user is out of a predetermined normal range) through a sense such as sight and hearing. For example, it is possible to sound an alarm or turn on/off a warning light, using a buzzer or an LED (Light Emitting Diode), or it is possible to output an alarm exhibiting the motion state of a user by displaying information through the display unit 160.

The alarm unit 140 can output an alarm so that a user can feel his/her motion state. That is, the alarm unit 140, for example, may include a motor (not illustrated) and it can let a user know his/her motion state by outputting vibration with the motor.

The input unit 150 can receive information from a user.

In detail, the input unit 150 may be composed of several function keys, and in this case, it sends key input data corresponding to the key pressed by a user to the control unit 130. The input unit 150, for example, may be a button unit (that is, physical button) (not illustrated) and the display unit 160, for example, may be a screen unit (not illustrated). That is, a user can make key input by touching a button unit (not illustrated) and a graphic can be outputted through a screen unit (not illustrated).

In addition, the functions of the input unit 150 and the display unit 160 may be achieved by a touch screen unit (not illustrated), and in this case, the touch screen unit (not illustrated) is in charge of touch screen input through a touch on a screen by a user and graphic output through a touch screen.

The display unit 160 can display output from the control unit 130.

In detail, the display unit 160 displays state information created in the operation of the smart band 100, a limited number of letters, and a large amount of video images and still images. The display unit 160 may include, for example, a liquid crystal display (LCD).

The communication module 170 can communicate with an electronic device around (for example, a smartphone) in response to signals from the control unit 130.

In detail, the communication module 170 encodes signals from the control unit 130, transmits them to an electronic device around (for example, a smartphone), using local wireless communication such as Bluetooth, ZigBee, infrared, UWB (Ultra Wide Band), WLAN (Wireless LAN), and NFC (Near Field Communication), decodes signals transmitted from the electronic device around through local wireless communication, and then transmits them to the control unit 130.

Though not illustrated in FIG. 2, the smart band 100 may further include a filter (not illustrated) (for example, a notch filter) which removes noises generated in integrating of motion data (for example, acceleration data or angular velocity data). In detail, the filter (not illustrated) may be used to remove sections with noises in motion data before the motion data is integrated and to remove noises generated after the integral calculus.

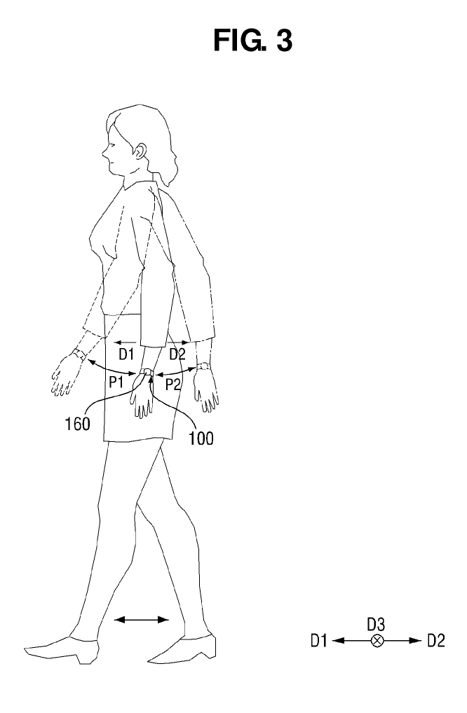

The scores of the first to third factors determined by the control unit illustrated in FIG. 2 are described hereafter with reference to FIGS. 3 to 6.

FIGS. 3 to 6 are diagrams illustrating the scores of the first to third factors determined by the control unit illustrated in FIG. 2.

Referring FIGS. 2 and 3 first, the walking figure of a user swing his/her arms forward/backward is illustrated. That is, in general, people naturally swing their arms forward/backward (in a walking direction), when they walk, but the swing angles of the arms may be different. Further, the longer the time for one step (that is, the larger the stride), the more the body is fatigued.

The first factor that is a standard for determining the motion state of a user is based on this concern. That is, the score of the first factor may be determined on the basis of first movement time when a user's arm reaches a first peak angle P1 in a first direction D1 of the arm swing directions by a user walking and second movement time when the user's arm reaches a second peak angle P2 in a second direction D2 opposite to the first direction, from the state S1 when the user's arm is in parallel with his/her body.

In detail, for an integral value of the angular velocity component in a third direction D3 crossing the first and second directions D1 and D2 (for example, the direction perpendicular to the liquid crystal surface of the display unit 160 of the smart band 100) (that is, for the forward/backward swing directions of an arm (first and second directions D2)), the first peak angle P1 in the first direction D1 and the second peak angle P2 in the second direction D2 are extracted and then the score of the first factor can be determined on the basis of the movement time between the first peak angle P1 and the second peak angle P2. In the present invention, a filter may be used to remove noises that are generated when the acceleration component and the angular velocity component are integrated. Since noises may be generated, the score of the first factor may be calculated, for example, from <Equation 1>.

Score of first factor=(10000−((average of first movement time+average of second movement time)/2)̂2)/100) <Equation 1>

The first movement time and the second movement time may be measured several times and it is possible to obtain the average of the first movement time and the average of the second movement time by extracting data corresponding to a specific range (for example, 90˜110% of the average range) in the first movement time and the second movement time that have been measured several times, but the present invention is not limited thereto.

As described above, the score of the first factor can be determined on the basis of the rotation angular velocity of a user's motion, and the larger the sum of the first and second movement time, the smaller the score of the first factor may be.

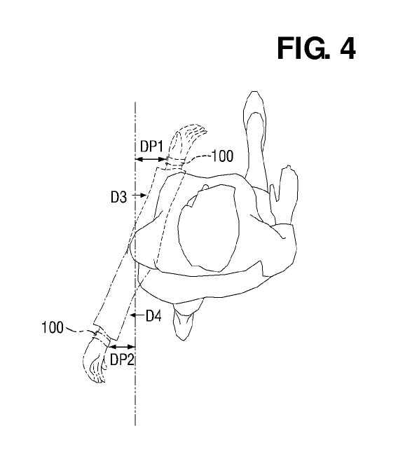

Next, referring to FIG. 4, the figure of a user swinging his/her arms forward/backward in walking is illustrated. That is, people generally swing their arms forward/backward (that is, away from/toward their bodies), when they walk, but the forward/backward swing angles of the arms may be different. Further, in most cases, the larger the forward/backward swing range of arms, the more the body turns, and the more the body turns in walking, the more the pelvis may be damaged.

The second factor that is a standard for determining the motion state of a user is based on this concern. That is, the score of the second factor may be determined on the basis of a first peak displacement DP1 in the third direction D3 of the arm swing directions by a user walking and a second peak displacement DP2 in a fourth direction D4 opposite to the third direction D3, from the state (S1 in FIG. 3) when the user's arm is in parallel with his/her body.

In detail, for an integral value of the acceleration component in the third direction D3 (for example, in the direction perpendicular to the liquid crystal surface of the display unit (160 in FIG. 3) of the smart band (100 in FIG. 3)) (that is, for the forward/backward arm swing directions (third and fourth directions D4)), the first peak displacement DP1 in the third direction D3 and the second peak displacement DP2 in the fourth direction D4 are extracted and the score of the second factor can be determined on the basis of the displacement.

The score of the second factor may be calculated, for example, from <Equation 2>.

Score of second factor=(50/(((average of first peak displacement+average of second peak displacement)/2)×10)) <Equation 2>

The first peak displacement DP1 and the second peak displacement DP2 may be measured several times and the score of the second factor can be determined on the basis of the average of the first peak displacement DP1 and the second peak displacement DP 2 which have been measured several times.

As described above, the score of the second factor can be determined on the basis of the acceleration of a user's motion, and the larger the sum of the first and second peak displacement, the smaller the score of the second factor may be.

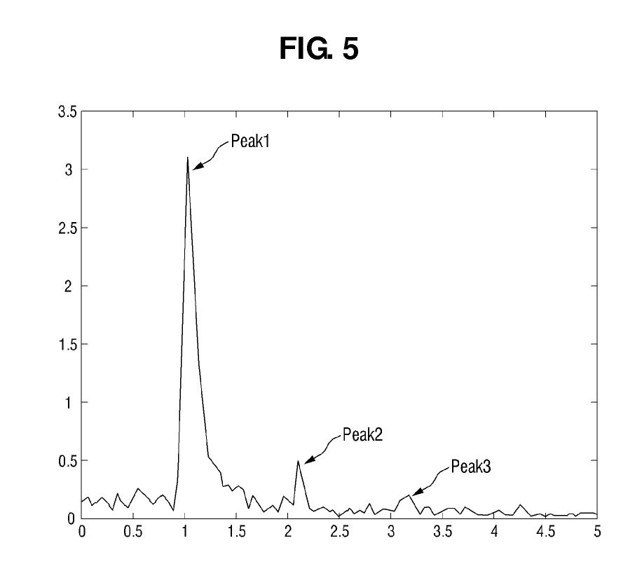

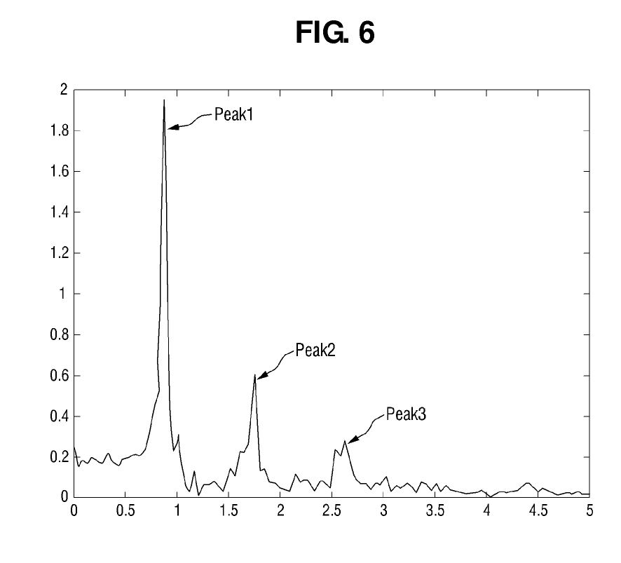

Next, referring to FIGS. 5 and 6, it is possible to find out whether user's walking is periodic and whether the walking applies shocks to the user's feet through frequency analysis on the integral value of the rotation angular velocity of a user's motion.

In detail, FIGS. 5 and 6 are graphs obtained by Fourier transform on the integral value of the angular velocity component in the third direction (D3 in FIG. 3) crossing the first and second directions (D1 and D2 in FIG. 3) described in relation to FIG. 3 (for example, the direction perpendicular to the liquid crystal surface of the display unit 160 of the smart band 100).

Referring to FIG. 5 first, which is a graph in good walking, it can be seen that the other peaks (for example, a second peak Peak2 and a third peak Peak3) are smaller than a first peak Peak1.

In contrast, referring to FIG. 6, which is a graph in bad walking, it can be seen that the other peaks (for example, a second peak Peak2 and a third peak Peak3) are larger than a first peak Peak1, as compared with FIG. 5.

That is, when there is another peak other than a main peak (for example, the first peak Peak1) or another peak is larger than the main peak, it may mean that the walking has many noises, that is, the walking is not periodic and applies shocks to the feet.

Accordingly, the third factor that is a standard for determining the motion state of a user is based on this concern. That is, the score of the third factor can be determined on the basis of the sum of the magnitudes of the other peaks (for example, second and third peaks Peak3) to the magnitude of the first peak (that is, the first peak Peak1) in the frequency domain of the integral value of a rotation angular velocity in the third direction D3 illustrated in FIG. 3, after performing Fourier transform on the integral value of the rotation angular velocity.

The ratio of the magnitude of the first peak and the sum of the magnitudes of the second and third peaks may be calculated from a specific function (for example, WalkMeterCalc).

The score of the third factor may be calculated, for example, from <Equation 3>.

Score of third factor=100−(WalkMeterCalc(gyro(2,:))×50) <Equation 3>

The other peaks are not limited to the second and third peaks and an additional peak may be included other than the second and third peaks.

As described above, the score of the third factor can be determined on the basis of the rotation angular velocity of a user's motion, and the larger the sum of the magnitudes of the other peaks except for the first peak, the smaller the score of the third factor may be.

To sum up, the final score is calculated by the control unit (130 in FIG. 2) on the basis of the scores of the first to third factors calculated in the way described above and the control unit (130 in FIG. 2) can determine the motion state of the user by comparing the final score with the normal motion score of the user stored in the memory (120 in FIG. 2).

The final score may be calculated, for example, from <Equation 4>.

Final score=score of first factor×score of second factor×score of third factor/10000 <Equation 4>

The normal motion score of a user may be the score of, for example, not a specific point, but a specific range. When the final score is higher than the normal motion score of a user, it may mean a good walking, and when the final score is lower than the normal motion score of a user, it may mean a bad walking.

The alarm unit (140 in FIG. 2) described above may alarm the user, when the final score is lower than the normal motion score.

The smart band 100 according to an embodiment of the present invention can provide an alarm in real time, when the final score is lower than the normal motion score of a user, by analyzing the health degree of the user's walking, using the motion sensor 110 and the control unit 130. Further, the smart band 100 can assist a user to keep good walking by providing an alarm in real time, as described above.

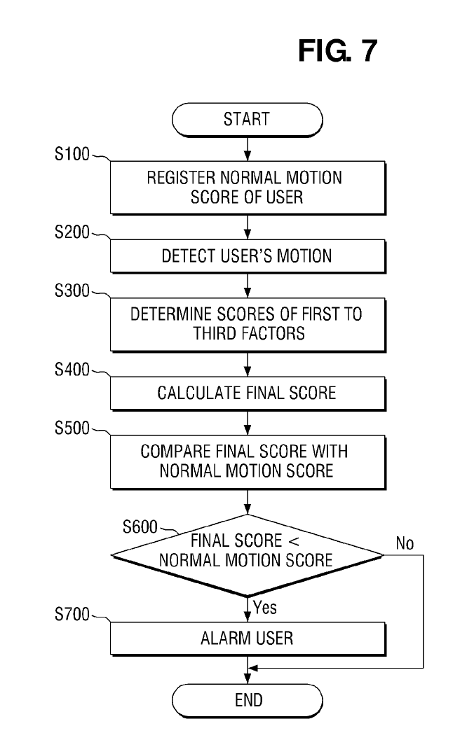

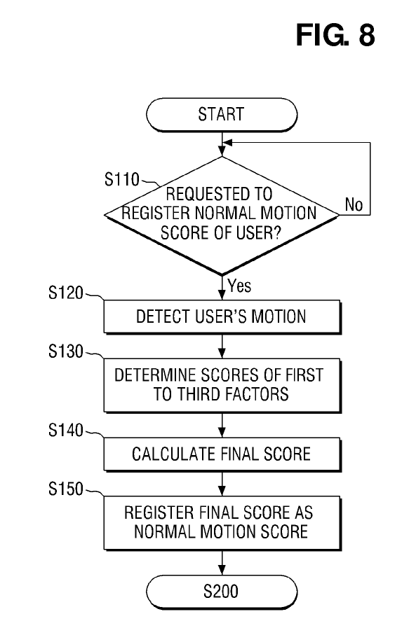

A method of determining a motion of the smart band is described hereafter with reference to FIGS. 7 and 8.

FIG. 7 is a flowchart illustrating a method of determining a motion through the smart band according to an embodiment of the present invention. FIG. 8 is a flowchart illustrating steps for registering a normal motion score of a user of FIG. 7.

Referring to FIG. 7, a normal motion score of a user is registered first (S100).

In detail, referring to FIGS. 2 to 8, when requested to register a normal motion score by a user operating a key (S110), the smart band 100 creates motion data by activating the motion sensor 110 and detecting a user's motion for a predetermined time with the motion sensor 110 (S120). For example, when the motion sensor 110 is an acceleration sensor, the smart band 100 measures the acceleration of a user's motion and creates acceleration data, and when the motion sensor 110 is a gyroscope, it measures a rotation angular velocity of a user's motion and creates angular velocity data. The acceleration data contains three axial (x-, y-, and z-axial) acceleration components and the angular velocity data contains three axial angular velocity components.

Next, the smart band 100 determines the scores of the first to third factors on the basis of the motion data created on the motion for a predetermined time (S130).

In detail, determining the score of the first factor may include measuring, several times, first movement time when a user's arm reaches a first peak angle (P1 in FIG. 3) in a first direction (D1 in FIG. 3) of the arm swing directions by a user walking and second movement time when the user's arm reaches a second peak angle (P2 in FIG. 3) in a second direction (D2 in FIG. 3) opposite to the first direction (D1 in FIG. 3), from the state (S1 in FIG. 3) when the user's arm is in parallel with his/her body, and determining the score of the first factor on the basis of the averages of each of the first and second movement time.

Determining the score of the second factor may include measuring, several times, a first peak displacement (DP1 in FIG. 4) in a third direction (D3 in FIG. 4) crossing a first direction (D1 in FIG. 4) of the arm swing directions by a user walking and a second peak displacement (DP2 in FIG. 4) in a fourth direction (D4 in FIG. 4) opposite to the third direction (D3 in FIG. 4), from the state (S1 in FIG. 4) when the user's arm is in parallel with his/her body, and determining the score of the second factor on the basis of the averages of the first and second peak displacements (DP1 and DP2 in FIG. 4) measured several times.

Determining the score of the third factor may include transforming the integral value of the rotation angular velocity of a user's motion into a frequency domain through Fourier transform and determining the score of the third factor on the basis of the ratio of the sum of the magnitudes of the other peaks to the magnitude of the first peak in the frequency domain of the integral value of the rotation angular velocity.

Next, the final score is calculated (S140).

In detail, the control unit 130 can calculate the final score by summing up the scores of the first to third factors.

Finally, the final score is registered as a normal motion score (S150).

In detail, the control unit 130 can register and store the calculated final score as the normal motion score of a user on the memory 120.

Referring to FIGS. 2 to 7 again, a user's motion is detected (S200).

In detail, after the normal motion score of the user is registered (S100), the motion sensor 110 is activated periodically or by the controlling of the control unit 130 and detects the user's motion for a predetermined time, thereby capable of creating motion data. For example, when the motion sensor 110 is an acceleration sensor, the smart band 100 measures the acceleration of a user's motion and creates acceleration data, and when the motion sensor 110 is a gyroscope, it measures a rotation angular velocity of a user's motion and creates angular velocity data. The acceleration data contains three axial (x-, y-, and z-axial) acceleration components and the angular velocity data contains three axial angular velocity components.

Next, the smart band 100 determines the scores of the first to third factors on the basis of the motion data created on the motion for a predetermined time (S300).

In detail, determining the score of the first factor may include measuring, several times, first movement time when a user's arm reaches a first peak angle (P1 in FIG. 3) in a first direction (D1 in FIG. 3) of the arm swing directions by a user walking and second movement time when the user's arm reaches a second peak angle (P2 in FIG. 3) in a second direction (D2 in FIG. 3) opposite to the first direction (D1 in FIG. 3), from the state (S1 in FIG. 3) when the user's arm is in parallel with his/her body, and determining the score of the first factor on the basis of the averages of each of the first and second movement time.

Determining the score of the second factor may include measuring, several times, a first peak displacement (DP1 in FIG. 4) in a third direction (D3 in FIG. 4) crossing a first direction (D1 in FIG. 4) of the arm swing directions by a user walking and a second peak displacement (DP2 in FIG. 4) in a fourth direction (D4 in FIG. 4) opposite to the third direction (D3 in FIG. 4), from the state (S1 in FIG. 4) when the user's arm is in parallel with his/her body, and determining the score of the second factor on the basis of the averages of the first and second peak displacements (DP1 and DP2 in FIG. 4) measured several times.

Determining the score of the third factor may include transforming the integral value of the rotation angular velocity of a user's motion into a frequency domain through Fourier transform and determining the score of the third factor on the basis of the ratio of the sum of the magnitudes of the other peaks to the magnitude of the first peak in the frequency domain of the integral value of the rotation angular velocity.

Next, the final score is calculated (S400).

In detail, the control unit 130 can calculate the final score by summing up the scores of the first to third factors.

The final score and the normal motion score are compared (S500).

In detail, the control unit 130 can determine whether the final score is smaller than the normal motion score or not by comparing the final score with the normal motion score stored in the memory 120 (S600).

When the final score is smaller than the normal motion score, the control unit 130 sends a signal to the alarm unit 140 and the alarm unit 140 alarms the user (S700). When the final score is larger than or the same as the normal motion score, the control unit 130 may not send a signal to the alarm unit 140, but the present invention is not limited thereto. That is, even though the final score is larger than or the same as the normal motion score, the control unit 130 can send a signal to the alarm unit 140 and the alarm unit 140 can alarm the user accordingly. Obviously, the alarm 140 may alarm the user in different ways, when the final score is smaller than, the same as, and larger than the normal motion score.

Thereafter, the smart band 100 ends the algorithm according to an embodiment of the present invention.

The method of determining a motion of a smart band according to embodiments of the present invention described above can be achieved as a computer-readable code or program on a computer-readable recording medium. The computer-readable recording medium includes all kinds of recording media storing data readably by a computer system. That is, the computer-readable media may include program commands, data files, and data structures, or combinations thereof. The program command that are recorded on the recording media may be those specifically designed and configure for the present invention or may be those available and known those engaged in computer software in the art. The computer-readable recording medium may be ROM, RAM, CD-ROM, magnetic tape, floppy disc, and optical data storage, and may be implemented in a carrier wave type (for example, transmitted by internet). The computer-readable recording medium may be distributed to a computer system that is connected through a network and may store and execute computer-readable codes in the type of distribution.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A smart band comprising:
a motion sensor that detects a user's motion and creates motion data;
a memory that stores a normal motion score of a user; and
a control unit that determines scores of each of first to third factors, which are standards for determining a user's motion state, on the basis of the created motion data, calculates a final score on the basis of the determined scores of each of the first to third factors, and determines the user's motion state by comparing the normal motion score with the final score.

2. The smart band of claim 1, wherein the motion data contains acceleration or rotation angular velocity of the user's motion.

3. The smart band of claim 1, wherein the score of the first factor is determined on the basis of first movement time when a user's arm reaches a first peak angle in a first direction of arm swing directions by a user walking and second movement time when the user's arm reaches a second peak angle in a second direction opposite to the first direction, from a state when the user's arm is in parallel with the user's body.

4. The smart band of claim 3, wherein the larger the sum of the first and second movement time, the smaller the score of the first factor.

5. The smart band of claim 3, wherein the score of the first factor is determined on the basis of the rotation angular velocity of the user's motion.

6. The smart band of claim 3, wherein the score of the second factor is determined on the basis of a first peak displacement in a third direction crossing the first direction of arm swing directions by a user walking and a second peak displacement in a fourth direction opposite to the third direction, from a state when the user's arm is in parallel with the user's body.

7. The smart band of claim 6, wherein the larger the sum of the first and second peak displacements, the smaller the score of the second factor.

8. The smart band of claim 6, wherein the score of the second factor is determined on the basis of the acceleration of the user's motion.

9. The smart band of claim 1, wherein the score of the third factor is determined on the basis of frequency analysis on the rotation angular velocity of the user's motion.

10. The smart band of claim 9, wherein the frequency analysis is performed by Fourier transform on the rotation angular velocity, and
the larger the ratio of the sum of the magnitudes of the other peaks to the magnitude of the first peak in a frequency domain of the rotation angular velocity, the smaller the score of the third factor.

11. The smart band of claim 9, wherein the score of the third factor is determined on the basis of the rotation angular velocity of the user's motion.

12. The smart band of claim 1, further comprising:
an alarm unit that alarms a user, when the final score is lower than the normal motion score.

13. A method of determining a motion state of a smart band, the method comprising:
detecting a user's motion and creating motion data;
determining scores of each of first to third factors, which are standards for determining a user's motion state, on the basis of the created motion data;
calculating a final score on the basis of the determined scores of each of the first to third factors; and
determining the user's motion state by comparing the normal motion score with the final score.

14. The method of claim 13, wherein the determining of the score of the first factor includes:
measuring, several times, first movement time when a user's arm reaches a first peak angle in a first direction of the arm swing directions by a user walking and second movement time when the user's arm reaches a second peak angle in a second direction opposite to the first direction, from a state when the user's arm is in parallel with the user's body; and
determining the score of the first factor on the basis of the averages of each of the first and second movement time measured several times.

15. The method of claim 14, wherein the larger the sum of the first and second movement time, the smaller the score of the first factor.

16. The method of claim 14, wherein the determining of the score of the second factor includes:
measuring, several times, a first peak displacement in a third direction crossing a first direction of the arm swing directions by a user walking and a second peak displacement in a fourth direction opposite to the third direction, from a state when the user's arm is in parallel with the user's body; and
determining the score of the second factor on the basis of the averages of each of the first and second peak displacements measured several times.

17. The method of claim 16, wherein the larger the sum of the first and second peak displacements, the smaller the score of the second factor.

18. The method of claim 13, wherein the determining of the score of the third factor includes:
transforming the rotation angular velocity of a user's motion into a frequency domain through Fourier transform; and
determining the score of the third factor on the basis of the ratio of the sum of the magnitudes of the other peaks to the magnitude of the first peak in the frequency domain of the rotation angular velocity.

19. The method of claim 13, further comprising:
registering a normal motion score of a user to be compared with the final score, before the detecting of a user's motion and creating of motion data.

20. The method of claim 13, further comprising alarming a user, when the final score is lower than the normal motion score.
